(19) United States
(12) Patent Application Publication
(10) Pub. No.: US 2024/0275093 A1
(43) Pub. Date: Aug. 15, 2024

(54) FLEXIBLE CABLE CONNECTOR AND METHOD FOR MANUFACTURING FLEXIBLE CABLE CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Pipatthana PHATIWUTTIPAT, Mie (JP)

(21) Appl. No.: 18/290,440

(22) PCT Filed: Mar. 23, 2022
(86) PCT No.: PCT/JP2022/013446

§ 371 Date: Nov. 13, 2023

(30) Foreign Application Priority Data
May 26, 2021 (JP) 2021-088199

(51) Int. Cl. H01R 12/77

(52) U.S. Cl. CPC H01R 12/771

(57) ABSTRACT

A flexible cable connector is provided with a first housing formed with a plurality of first terminal accommodation chambers, a second housing formed with a plurality of second terminal accommodation chambers, a plurality of terminal fittings to be individually mounted into the plurality of first terminal accommodation chambers, a plurality of terminal fittings to be individually mounted into the plurality of second terminal accommodation chambers, a first flexible cable to be fixed to the plurality of terminal fittings by welding, and a second flexible cable to be fixed to the plurality of terminal fittings by welding. The first housing is formed with first openings for exposing a welded part of the plurality of terminal fittings and the first flexible cable. The second housing is formed with a second opening for exposing a welded part of the plurality of terminal fittings and the second flexible cable.

### TECHNICAL FIELD

The present disclosure relates to a flexible cable connector and a method for manufacturing a flexible cable connector.

### BACKGROUND

Patent Document 1 discloses a connector in which a plurality of terminal fittings are fixed in parallel to an end part of a flat cable by welding and the terminal fittings fixed to the flat cable are mounted in a lower housing and an upper housing.

### PRIOR ART DOCUMENT

### Patent Document

Patent Document 1: Republication of WO 2019/188738

### SUMMARY OF THE INVENTION

### Problems to be Solved

In welding the terminal fittings and the flat cable, a step of positioning the plurality of terminal fittings in alignment by being set in a jig, a step of fixing the positioned terminal fittings and the flat cable, a step of removing the plurality of terminal fittings from the jig and a step of mounting the terminal fittings into the lower housing and the upper housing are necessary. Thus, conventional connectors have a problem of requiring many assembly man-hours.

A flexible cable connector of the present disclosure was completed on the basis of the above situation and aims to reduce assembly man-hours.

### Means to Solve the Problem

A first aspect of the present disclosure is directed to a flexible cable connector with a housing formed with a plurality of terminal accommodation chambers, a plurality of terminal fittings to be individually mounted into the plurality of terminal accommodation chambers, and a flexible cable to be fixed to the plurality of terminal fittings by welding, the housing being formed with an opening for exposing a welded part of the plurality of terminal fittings and the flexible cable.

A second aspect of the present disclosure is directed to a method for manufacturing a flexible cable connector, the method including forming an opening in a housing formed with a plurality of terminal accommodation chambers, individually mounting a plurality of terminal fittings into the plurality of terminal accommodation chambers, exposing a welded part of the plurality of terminal fittings and the flexible cable in the opening by aligning the positions of the housing and the flexible cable, and fixing the plurality of terminal fittings and the flexible cable by welding.

### Effect of the Invention

According to the first and second aspects of the present disclosure, assembly man-hours can be reduced.

### BRIEF DESCRIPTION OF THE DRAWINGS

FIG. 1 is a perspective view of a flexible cable connector of one embodiment.

FIG. 2 is a perspective view showing a state where the flexible cable connector is divided into an upper housing and an inner module.

FIG. 3 is a bottom view of a first module.

FIG. 4 is a perspective view showing a state where the first module is divided.

FIG. 5 is a plan view of a second module.

FIG. 6 is a perspective view showing a state where the second module is divided.

FIG. 7 is a front view in section of the flexible cable connector.

### DETAILED DESCRIPTION TO EXECUTE THE INVENTION

### Description of Embodiments of Present Disclosure

First, embodiments of the present disclosure are listed and described.
(1) The flexible cable connector according to the first aspect of the present disclosure is provided with a housing formed with a plurality of terminal accommodation chambers, a plurality of terminal fittings to be individually mounted into the plurality of terminal accommodation chambers, and a flexible cable to be fixed to the plurality of terminal fittings by welding, the housing being formed with an opening for exposing a welded part of the plurality of terminal fittings and the flexible cable. According to the first aspect of the present disclosure, the flexible cable connector can be assembled by a step of accommodating the plurality of terminal fittings into the terminal accommodation chambers, a step of aligning the positions of the flexible cable and the housing and a step of welding the plurality of terminal fittings and the flexible cable. Since a welded state can be confirmed in the opening after welding, a step of removing the terminal fittings from the terminal accommodation chambers to confirm the welded state is not necessary. Since the plurality of terminal fittings are aligned by being mounted into the terminal accommodation chambers, a step of attaching and detaching the plurality of terminal fittings to and from a jig to align the terminal fittings is not necessary. Since the step of attaching and detaching the terminal fittings to and from the jig is not necessary, assembly man-hours can be reduced.
(2) Preferably, the opening is open to expose an outer peripheral edge of a welded section of the flexible cable to the plurality of terminal fittings. According to this configuration, the position of the flexible cable with respect to the housing and the plurality of terminal fittings can be confirmed visually or by a camera or the like.
(3) Preferably, the housing and the flexible cable are formed with positioning holes to be aligned with each other. According to this configuration, the flexible cable can be positioned with respect to the housing and the terminal fittings by aligning the positions of the positioning hole of the housing and the positioning hole of the flexible cable.
(4) Preferably, in (3), a boss pin is provided which is to be fit into the positioning hole of the housing and the positioning hole of the flexible cable with the flexible cable and the plurality of terminal fittings welded. According to this configuration, a position shift of the flexible cable with respect to the housing is prevented by fitting the boss pin into the positioning hole of the housing and the positioning hole of the flexible cable. In this way, the separation of the terminal fittings mounted in the housing and the flexible cable can be prevented even if a tensile force acts on the flexible cable.
(5) The method for manufacturing a flexible cable connector according to the second aspect of the present disclosure includes forming an opening in a housing formed with a plurality of terminal accommodation chambers, individually mounting a plurality of terminal fittings into the plurality of terminal accommodation chambers, exposing a welded part of the plurality of terminal fittings and the flexible cable in the opening by aligning the positions of the housing and the flexible cable, and fixing the plurality of terminal fittings and the flexible cable by welding. According to the second aspect of the present disclosure, since a welded state can be confirmed in the opening after welding, a step of removing the terminal fittings from the terminal accommodation chambers to confirm the welded state is not necessary. Since the terminal fittings are aligned by being mounted into the terminal accommodation chambers, a step of attaching and detaching the plurality of terminal fittings to and from a jig is not necessary. Since the step of attaching and detaching the terminal fittings to and from the jig is not necessary, assembly man-hours can be reduced.
(6) Preferably, in (5), the flexible cable and the housing are aligned in position while a positional relationship of the plurality of terminal fittings and the flexible cable connector is confirmed in the opening. According to this configuration, since the positional relationship of the flexible cable and the plurality of terminal fittings can be confirmed in the opening, the plurality of terminal fittings and the flexible cable can be aligned in position with high accuracy.

### Details of Embodiment of Present Disclosure

### Embodiment

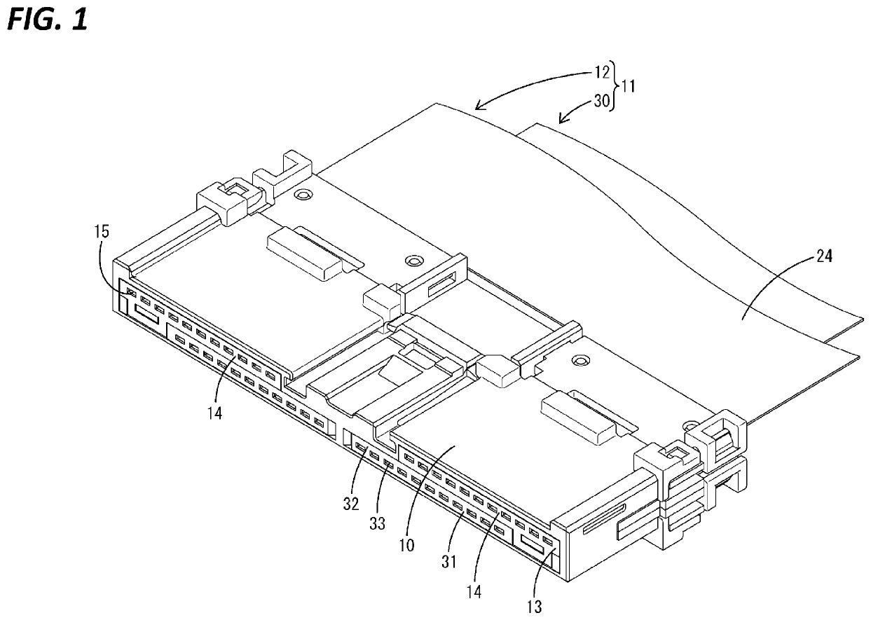

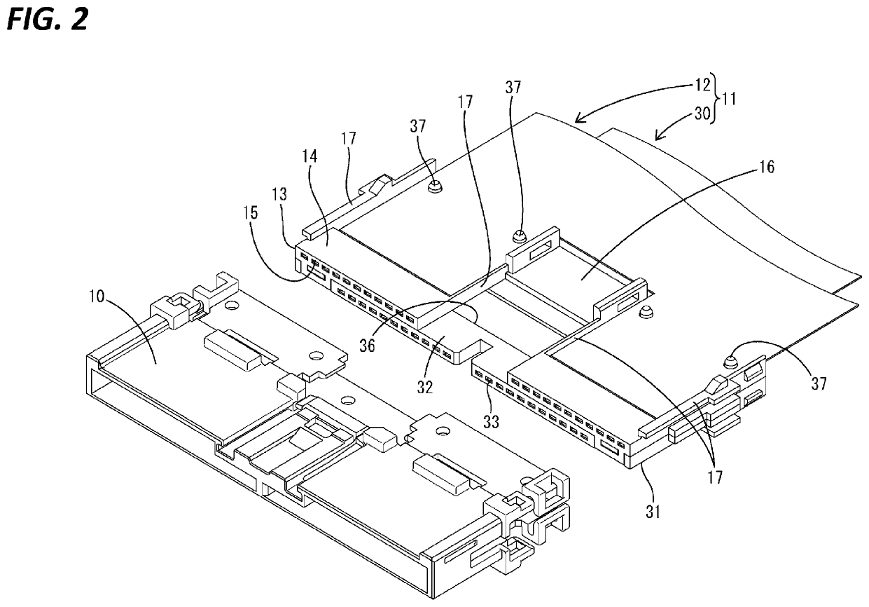

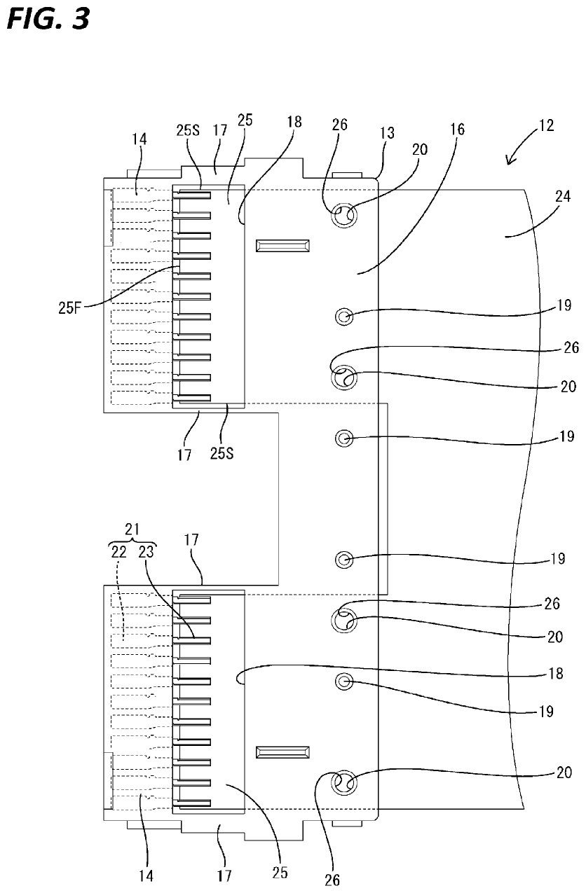

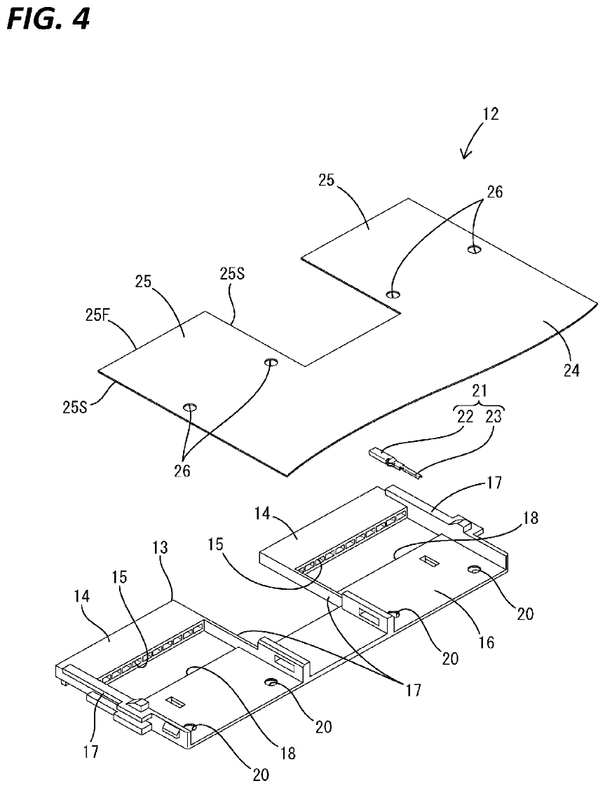

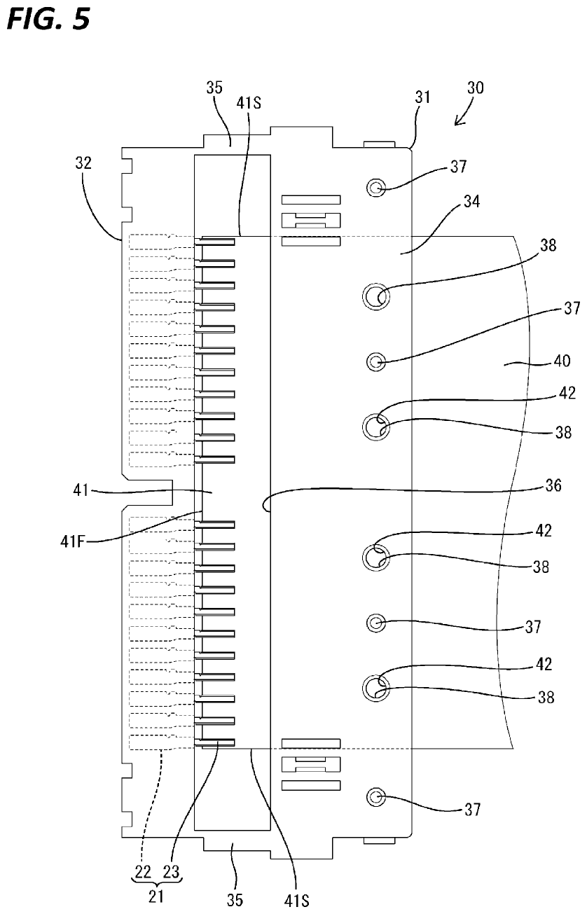

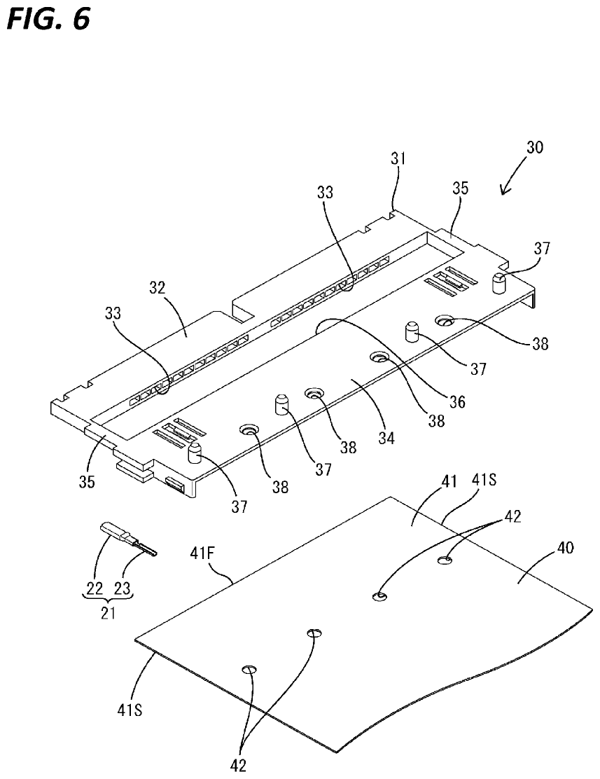

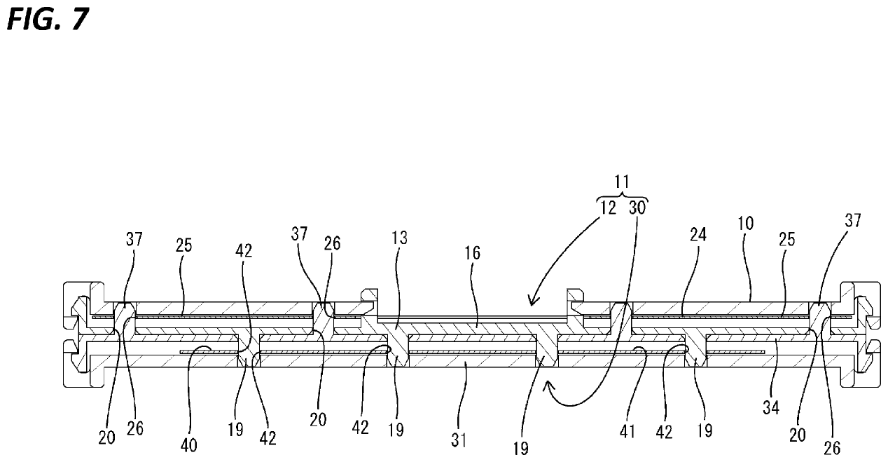

One specific embodiment of a flexible cable connector and a method for manufacturing a flexible cable connector of the present disclosure is described below with reference to FIGS. 1 to 7. Note that the present invention is not limited to these illustrations, but is represented by claims and intended to include all changes in the scope of claims and in the meaning and scope of equivalents. In this embodiment, an oblique left-lower side in FIGS. 1 and 2, an oblique left-upper side in FIGS. 4 and 6 and a left side in FIGS. 3 and 5 are defined as a front side concerning a front-rear direction. Upper and lower sides shown in FIGS. 1, 2, 4, 6 and 7 are directly defined as upper and lower sides concerning a vertical direction. The vertical direction and a height direction are used as synonyms. A lateral direction and a width direction are used as synonyms.

A flexible cable connector of this embodiment is configured by assembling one outer housing 10 and one inner module 11. As shown in FIGS. 1 and 2, the outer housing 10 has a flat rectangular parallelepiped shape having a length in the front-rear direction larger than a height in the vertical direction and having a width in the lateral direction larger than the length. The outer housing 10 is in the form of a rectangular tube having open front and rear end surfaces. The inner module 11 is configured by stacking a first module 12 and a second module 30 in the vertical direction as shown in FIG. 2.

As shown in FIGS. 3 and 4, the first module 12 is configured by assembling one first housing 13, a plurality of terminal fittings 21 and one first flexible cable 24. The first housing 13 has a flat shape having a length in the front-rear direction larger than a height in the vertical direction and having a width in the lateral direction larger than the length. The first housing 13 is a single component including a pair of left and right first terminal accommodating portions 14 spaced apart in the width direction, one first base plate portion 16 arranged behind the first terminal accommodating portions 14 and elongated in the width direction and four first linking portions 17.

The first terminal accommodating portion 14 has a flat shape having a length in the front-rear direction larger than a height in the vertical direction and having a width in the lateral direction larger than the length. A plurality of first terminal accommodation chambers 15 arranged in the width direction are formed in the first terminal accommodating portion 14. The first base plate portion 16 is formed over the entire width region of the first housing 13. The first base plate portion 16 is located at the same height as the lower surface walls of the first terminal accommodating portions 14.

The four first linking portions 17 are shaped to be elongated in the front-rear direction and arranged apart from each other in the width direction. The four first linking portions 17 link rear end parts of the pair of first terminal accommodating portions 14 and a front end part of the first base plate portion 16. Two first linking portions 17 located on widthwise outer sides link outer ones of both widthwise end parts of the pair of first terminal accommodating portions 14 and both widthwise end parts of the first base plate portion 16. Two first linking portions 17 located in a widthwise central part link inner ones of the both widthwise end parts of the pair of first terminal accommodating portions 14 and the front end part of the first base plate portion 16.

The first housing 13 is formed with a pair of first openings 18 spaced apart in the width direction. One first opening 18 is an opening defined by the rear end edge of the first terminal accommodating portion 14, a pair of the first linking portions 17 and a part of the front end edge of the first base plate portion 16. The first opening 18 is a space having a rectangular shape in a plan view of the first housing 13 and penetrating through the first housing 13 in the vertical direction. Openings at the rear ends of the first terminal accommodation chambers 15 are facing the first openings 18.

Four first boss pins 19 projecting downward are formed on the lower surface of the first base plate portion 16. The four first boss pins 19 are spaced apart in the width direction and arranged in a row in the width direction. Out of the four first boss pins 19, two first boss pins 19 located in a center are arranged in a region between the pair of openings 18 in the width direction. Two first boss pins 19 on both widthwise end sides are arranged in formation regions of the first terminal accommodating portions 14 and the first openings 18 in the width direction.

The first base plate portion 16 is formed with four first fitting holes 20 penetrating through the first base plate portion 16 in the vertical direction, i.e. in a plate thickness direction. The first fitting holes 20 function as positioning holes. The four first fitting holes 20 are spaced apart in the width direction and arranged in a row in the width direction. The first fitting holes 20 are arranged at the same position as the first boss pins 19 in the front-rear direction. Out of the four first fitting holes 20, two first fitting holes 20 on a right side are arranged in the formation regions of the right first terminal accommodating portion 14 and the right first opening 18 in the width direction. The two first fitting holes 20 on the right side are arranged across one first boss pin 19 in the width direction. Two first fitting holes 20 on a left side are arranged in the formation regions of the left first terminal accommodating portion 14 and the left first opening 18 in the width direction. The two first fitting holes 20 on the left side are arranged across one first boss pin 19 in the width direction.

The terminal fitting 21 has a shape elongated in the front-rear direction as a whole. The terminal fitting 21 is a single component including a terminal body portion 22 to be connected to a mating terminal (not shown) and a fixing portion 23 extending rearward from the rear end of the terminal body portion 22. A plurality of the terminal fittings 21 are mounted into the first terminal accommodating portion 14 by individually inserting the terminal body portions 22 into a plurality of the first terminal accommodation chambers 15. With the plurality of terminal fittings 21 mounted in the first terminal accommodating portion 14, a plurality of the fixing portions 23 project rearwardly of the first terminal accommodating portion 14. In a plan view, the plurality of fixing portions 23 are arranged in an open region of the first opening 18 while being arranged in parallel in the width direction.

The first flexible cable 24 is a known one, in which conductive paths and circuits are formed on a base film, which is a flexible insulator in the form of a thin film. Specific examples of the first flexible cable include flexible printed circuit boards and flexible flat cables.

A pair of left and right first connecting end portions 25 serving as welded sections to the plurality of terminal fittings 21 are formed on a front end part of the first flexible cable 24. Formation ranges of the pair of first connecting end portions 25 in the width direction are only the formation regions of the first terminal accommodating portions 14 and the first openings 18. The first connecting end portions 25 are mounted on the first housing 13 to cover the plurality of fixing portions 23 arranged in parallel in the width direction from above. The plurality of fixing portions 23 arranged in parallel in the width direction are electrically conductively fixed to the lower surfaces of front end parts of the first connecting end portions 25 by a reflow process. A welded part of the fixing portions 23 and the first connecting end portion 25 is within the range of the first opening 18 in a plan view.

The first flexible cable 24 is formed with four first through holes 26 penetrating through the first flexible cable 24 in a thickness direction. The four first through holes 26 function as positioning holes. The four first through holes 26 are spaced apart in the width direction and arranged in a row in the width direction. Two first through holes 26 are arranged in one first connecting end portion 25. The four first through holes 26 are arranged at the same positions as the four first fitting holes 20 with the first flexible cable 24 mounted on the first housing 13.

The second module 30 is configured by assembling one second housing 31, a plurality of terminal fittings 21 and one second flexible cable 40. The second housing 31 has a flat shape having a length in the front-rear direction larger than a height in the vertical direction and having a width in the lateral direction larger than the length. The length in the front-rear direction of the second housing 31 is equal to that of the first housing 13. The width of the second housing 31 is equal to that of the first housing 13.

The second housing 31 is a single component including a second terminal accommodating portion 32 elongated in the width direction, a second base plate portion 34 arranged behind the second terminal accommodating portion 32 and elongated in the width direction, and a pair of second linking portions 35. The second terminal accommodating portion 32 has a flat shape having a length in the front-rear direction larger than a height in the vertical direction and having a width in the lateral direction larger than the length. A plurality of second terminal accommodation chambers 33 arranged in the width direction are formed in the second terminal accommodating portion 32. The second base plate portion 34 is formed over the entire width region of the second housing 31. The second base plate portion 34 is located at the same height as the upper surface wall of the second terminal accommodating portion 32.

The pair of second linking portions 35 have a shape elongated in the front-rear direction and are arranged apart from each other in the width direction. The pair of second linking portions 35 link both widthwise end parts of a rear end part of the second terminal accommodating portion 32 and both widthwise end parts of the front end edge of the second base plate portion 34.

The second housing 31 is formed with one second opening 36 spaced apart in the width direction. The second opening 36 is defined by the rear end edge of the second terminal accommodating portion 32, the pair of second linking portions 35 and the front end edge of the second base plate portion 34. The second opening 36 is a space having a rectangular shape in a plan view of the second housing 31 and penetrating through the second housing 31 in the vertical direction. Openings in the rear ends of the second terminal accommodation chambers 33 are facing the first opening 18.

Four second boss pins 37 projecting upward are formed on the upper surface of the second base plate portion 34. The four second boss pins 37 are spaced apart in the width direction and arranged in a row in the width direction. The four second boss pins 37 are arranged at positions to be fit into the fourth first fitting holes 20 and the four first through holes 26 with the first and second housings 13, 31 stacked.

The second base plate portion 34 is formed with four second fitting holes 38 penetrating through the second base plate portion 34 in the vertical direction, i.e. in a plate thickness direction. The second fitting holes 38 function as positioning holes. The four second fitting holes 38 are spaced apart in the width direction and arranged in a row in the width direction. The second fitting holes 38 are arranged at positions different from the first fitting holes 20 in the width direction. The second fitting holes 38 are arranged at the same position as the first and second boss pins 19, 37 in the front-rear direction. The four second fitting holes 38 are arranged to be fit to the four first boss pins 19 with the first and second housings 13, 31 stacked.

The terminal fittings 21 constituting the second module 30 are the same components as the terminal fittings 21 constituting the first module 12. The plurality of terminal fittings 21 are mounted into the second terminal accommodating portion 32 by individually inserting the terminal body portions 22 into the plurality of second terminal accommodation chambers 33. With the plurality of terminal fittings 21 mounted in the second terminal accommodating portion 32, a plurality of the fixing portions 23 project rearwardly of the second terminal accommodating portion 32. In a plan view, the plurality of fixing portions 23 are arranged in an open region of the second opening 36 while being arranged in parallel in the width direction.

Similarly to the first flexible cable 24, the second flexible cable 40 is a known one, in which conductive paths and circuits are formed on a base film, which is a flexible insulator in the form of a thin film. A second connecting end portion 41 functioning as a welded section to the plurality of terminal fittings 21 is formed on a front end part of the second flexible cable 40. A formation range of the second connecting end portion 41 in the width direction is a region slightly narrower than formation regions of the second terminal accommodating portion 32 and the second opening 36. The second connecting end portion 41 is mounted on the second housing 31 to cover the plurality of fixing portions 23 arranged in parallel in the width direction from below. The plurality of fixing portions 23 arranged in parallel in the width direction are electrically conductively fixed to the upper surface of a front end part of the second connecting end portion 41 by a reflow process. A welded part of the fixing portions 23 and the second connecting end portion 41 is within the range of the second opening 36 in a plan view.

The second connecting end portion 41 of the second flexible cable 40 is formed with four second through holes 42 penetrating through the second flexible cable 40 in the thickness direction. The second through holes 42 function as positioning holes. The four second through holes 42 are spaced apart in the width direction and arranged in a row in the width direction. The four second through holes 42 are arranged at the same positions as the four second fitting holes 38 with the second flexible cable 40 mounted on the second housing 31.

An assembling procedure of the flexible cable connector of this embodiment is described. On the side of the first module 12, solder paste (not shown) is applied to the first connecting end portions 25 of the first flexible cable 24 and the first flexible cable 24 is set in a jig (not shown) with the solder paste facing upward. By fitting the first through holes 26 to projections of the jig, the first flexible cable 24 is positioned. After the terminal fittings 21 are mounted into the first terminal accommodating portions 14, the first housing 13 is put on the upper surface of the first flexible cable 24 and the first fitting holes 20 are fit to the projections of the jig with the first housing 13 set in a vertically inverted posture. In this way, the first housing 13 and the first flexible cable 24 are positioned to each other.

In the first openings 18, front end edges 25F and both left and right side edges 25S of the first connecting end portions 25 are exposed and the fixing portions 23 placed on the upper surfaces of the first connecting end portions 25 are exposed. In this state, the jig, the first flexible cable 24, the first housing 13 and the terminal fittings 21 are accommodated into a reflow furnace (not shown), and the fixing portions 23 and the first connecting end portions 25 are fixed by welding. A state after welding can be inspected visually or optically by a camera or the like in the first openings 18. If the first flexible cable 24 and the first housing 13 are removed from the jig after fixing, the assembling of the first module 12 is completed and the first housing 13, the terminal fittings 21 and the first flexible cable 24 are integrated.

On the side of the second module 30, solder paste (not shown) is applied to the second connecting end portion 41 of the second flexible cable 40 and the second flexible cable 40 is set in a jig (not shown) with the solder paste facing upward. By fitting the second through holes 42 to projections of the jig, the second flexible cable 40 is positioned. After the terminal fittings 21 are mounted into the second terminal accommodating portions 32, the second housing 31 is put on the upper surface of the second flexible cable 40 and the second fitting holes 38 are fit to the projections of the jig. In this way, the second housing 31 and the second flexible cable 40 are positioned to each other.

In the second opening 36, a front end edge 41F and both left and right side edges 41S of the second connecting end portion 41 are exposed and the fixing portions 23 placed on the upper surface of the second connecting end portion 41 are exposed. In this state, the jig, the second flexible cable 40, the second housing 31 and the terminal fittings 21 are accommodated into a reflow furnace (not shown), and the fixing portions 23 and the second connecting end portion 41 are fixed by welding. A state after welding can be inspected visually or optically by a camera or the like in the second opening 36. If the second flexible cable 40 and the second housing 31 are removed from the jig after fixing, the assembling of the second module 30 is completed and the second housing 31, the terminal fittings 21 and the second flexible cable 40 are integrated.

Thereafter, the first housing 13 having the first boss pins 19 oriented to project downward is placed on and assembled with the upper surface of the second housing 31 having the second boss pins 37 oriented to project upward. With the both housings 13, 31 assembled, the first boss pins 19 are fit through the second fitting holes 38 and the second through holes 42. The second boss pins 37 are fit through the first fitting holes 20 and the first through holes 26. The both housings 13, 31 are united to be stacked in the vertical direction and positioned in the front-rear direction and width direction by the fitting action of these, and the assembling of the inner module 11 is completed.

With the first and second modules 12, 30 stacked, the first fitting holes 20 of the first housing 13 and the first through holes 26 of the first flexible cable 24 are fit to the common second boss pins 37, whereby the first housing 13 and the first flexible cable 24 are positioned in the front-rear direction and width direction. The second fitting holes 38 of the second housing 31 and the second through holes 42 of the second flexible cable 40 are fit to the common first boss pins 19, whereby the second housing 31 and the second flexible cable 40 are positioned in the front-rear direction and width direction. The first and second housings 13, 31 are positioned in the front-rear direction and width direction by fitting the first boss pins 19 of the first housing 13 and the second fitting holes 38 of the second housing 31 and fitting the second boss pins 37 of the second housing 31 and the first fitting holes 20 of the first housing 13. If the completely assembled inner module 11 is inserted into the outer housing 10 from behind, the assembling of the flexible cable connector is completed.

The flexible cable connector of this embodiment is provided with the first housing 13 formed with the plurality of first terminal accommodation chambers 15, the second housing 31 formed with the plurality of second terminal accommodation chambers 33, the plurality of terminal fittings 21 to be individually mounted into the plurality of first and second terminal accommodation chambers 15, 33, the first flexible cable 24 and the second flexible cable 40. The plurality of terminal fittings 21 are respectively fixed to one first flexible cable 24 and one second flexible cable 40 by welding. The first housing 13 is formed with the first openings 18 for exposing the welded part of the plurality of terminal fittings 21 and the first flexible cable 24. The second housing 31 is formed with the second opening 36 for exposing the welded part of the plurality of terminal fittings 21 and the second flexible cable 40.

The flexible cable connector of this embodiment is assembled by a step of accommodating the plurality of terminal fittings 21 into the first terminal accommodation chambers 15 and the second terminal accommodation chambers 33, a step of aligning the positions of the first flexible cable 24 and the first housing 13, a step of aligning the positions of the second flexible cable 40 and the second housing 31 and a step of welding the plurality of terminal fittings 21 to the first and second flexible cables 24, 40. Since the welded state can be confirmed in the first and second openings 18, 36 after welding, a step of removing the terminal fittings 21 from the first and second terminal accommodation chambers 15, 33 to confirm the welded state is not necessary. The plurality of terminal fittings 21 are aligned by being mounted into the first and second terminal accommodation chambers 15, 33. Therefore, a step of attaching and detaching the plurality of terminal fittings 21 to and from a jig is not necessary to align the terminal fittings 21. Since the step of attaching and detaching the terminal fittings 21 to and from the jig is not necessary, assembly man-hours can be reduced.

The first opening 18 is open to expose the outer peripheral edge of the welded section of the first flexible cable 24 to the plurality of terminal fittings 21. That is, in the first opening 18, the front end edges 25F and the both left and right side edges 2S of the first connecting end portion 25 are exposed. In the first opening 18, the position of the first flexible cable 24 with respect to the first housing 13 and the plurality of terminal fittings 21 can be confirmed visually or by a camera or the like. The second opening 36 is open to expose the outer peripheral edge of the welded section of the second flexible cable 40 to the plurality of terminal fittings 21. That is, in the second opening 36, the front end edges 41S and the both left and right side edges 41S of the second connecting end portion 41 are exposed. In the second opening 36, the position of the second flexible cable 40 with respect to the second housing 31 and the plurality of terminal fittings 21 can be confirmed visually or by a camera or the like.

The first housing 13 and the first flexible cable 24 are formed with the first fitting holes 20 and the first through holes 26 as the positioning holes to be aligned with each other. By aligning the positions of the fitting holes 20 and the first through holes 26, the first flexible cable 24 can be positioned with respect to the first housing 13 and the terminal fittings 21. The second housing 31 and the second flexible cable 40 are formed with the second fitting holes 38 and the second through holes 42 as the positioning holes to be aligned with each other. By aligning the positions of the fitting holes 38 and the second through holes 42, the second flexible cable 40 can be positioned with respect to the second housing 31 and the terminal fittings 21.

The first housing 13 is formed with the first boss pins 19 to be fit into the second fitting holes 38 and the second through holes 42 with the second flexible cable 40 and the plurality of terminal fittings 21 welded. By fitting the first boss pins 19 into the second fitting holes 38 and the second through holes 42, a position shift of the second flexible cable 40 with respect to the second housing 31 is prevented. In this way, even if a tensile force acts on the second flexible cable 40, the separation of the terminal fittings 21 mounted in the second housing 31 and the second flexible cable 40 can be prevented.

The second housing 31 is formed with the second boss pins 37 to be fit into the first fitting holes 20 and the first through holes 26 with the second flexible cable 24 and the plurality of terminal fittings 21 welded. By fitting the second boss pins 37 into the first fitting holes 20 and the first through holes 26, a position shift of the first flexible cable 24 with respect to the first housing 13 is prevented. In this way, even if a tensile force acts on the first flexible cable 24, the separation of the terminal fittings 21 mounted in the first housing 13 and the first flexible cable 24 can be prevented.

The first housing 13 formed with the plurality of first terminal accommodation chambers 15 is formed with the first openings 18, and the second housing 31 formed with the plurality of second terminal accommodation chambers 33 is formed with the second opening 36. The flexible cable connector including the first openings 18 and the second opening 36 is manufactured by the following procedure.

First, the plurality of terminal fittings 21 are individually mounted into the plurality of first terminal accommodation chambers 15 and the plurality of second terminal accommodation chambers 33. Subsequently, the first housing 13 and the first flexible cable 24 are aligned in position, whereby the welded part of the plurality of terminal fittings 21 and the first flexible cable 24, i.e. the fixing portions 23 and the first connecting end portions 25, is exposed in the first openings 18. Similarly, the second housing 31 and the second flexible cable 40 are aligned, whereby the welded part of the plurality of terminal fittings 21 and the second flexible cable 40, i.e. the fixing portions 23 and the second connecting end portion 41, is exposed in the second opening 36. Subsequently, the plurality of terminal fittings 21 and the first flexible cable 24 are fixed by welding, and the plurality of terminal fittings 21 and the second flexible cable 40 are fixed by welding.

Since the welded state can be confirmed in the first and second openings 18, 36 after welding, the step of removing the terminal fittings 21 from the first and second terminal accommodation chambers 15, 33 to confirm the welded state is not necessary. The plurality of terminal fittings 21 are aligned by being mounted into the first and second terminal accommodation chambers 15, 33. Therefore, the step of attaching and detaching the plurality of terminal fittings 21 to and from the jig to align the terminal fittings 21 is not necessary. Since the step of attaching and detaching the terminal fittings 21 to and from the jig is not necessary, the assembly man-hours can be reduced.

Further, when the first flexible cable 24 and the first housing 13 are aligned in position, a positional relationship of the plurality of terminal fittings 21 and the first connecting end portions 25 of the first flexible cable 24 is confirmed in the first openings 18. When the second flexible cable 40 and the second housing 31 are aligned in position, a positional relationship of the plurality of terminal fittings 21 and the second connecting end portion 41 of the second flexible cable 40 is confirmed in the second opening 36. According to this method, the position alignment of the fixing portions 23 of the plurality of terminal fittings 21 and the first connecting end portions 25 of the first flexible cable 24 and that of the fixing portions 23 of the plurality of terminal fittings 21 and the second connecting end portion 41 of the second flexible cable 40 can be performed with high accuracy.

### OTHER EMBODIMENTS

The present invention is not limited to the above described and illustrated embodiment, but is represented by claims. The present invention is intended to include all changes in the scope of claims and in the meaning and scope of equivalents and also include the following embodiments.

Although the open range of the first opening includes the outer peripheral edge of the welded section of the first flexible cable to the plurality of terminal fittings in the above embodiment, the open range of the first opening may not include the outer peripheral edge of the welded section of the first flexible cable to the plurality of terminal fittings.

Although the open range of the second opening includes the outer peripheral edge of the welded section of the second flexible cable to the plurality of terminal fittings in the above embodiment, the open range of the second opening may not include the outer peripheral edge of the welded section of the second flexible cable to the plurality of terminal fittings.

Although the first flexible cable is positioned with respect to the terminal fittings by aligning the positions of the first fitting holes and the first through holes, which are the positioning holes of the first housing and the first flexible cable, in the above embodiment, the first flexible cable may be positioned with respect to the terminal fittings by parts other than the first fitting holes and the first through holes.

Although the second flexible cable is positioned with respect to the terminal fittings by aligning the positions of the second fitting holes and the second through holes, which are the positioning holes of the second housing and the second flexible cable, in the above embodiment, the second flexible cable may be positioned with respect to the terminal fittings by parts other than the second fitting holes and the second through holes.

Although the second boss pins are fit into the first fitting holes serving as the positioning holes of the first housing and the first through holes serving as the positioning holes of the first flexible cable with the first flexible cable and the terminal fittings welded in the above embodiment, a structure may be adopted in which the second boss pins are not fit into the first fitting holes and the first through holes with the first flexible cable and the terminal fittings welded.

Although the first boss pins are fit into the second fitting holes serving as the positioning holes of the second housing and the second through holes serving as the positioning holes of the second flexible cable with the second flexible cable and the terminal fittings welded in the above embodiment, a structure may be adopted in which the first boss pins are not fit into the second fitting holes and the second through holes with the second flexible cable and the terminal fittings welded.

### LIST OF REFERENCE NUMERALS

2S . . . left and right side edges
10 . . . outer housing
11 . . . inner module
12 . . . first module
13 . . . first housing (housing)
14 . . . first terminal accommodating portion
15 . . . first terminal accommodation chamber (terminal accommodation chamber)
16 . . . first base plate portion
17 . . . first linking portion
18 . . . first opening (opening)
19 . . . first boss pin (boss pin)
20 . . . first fitting hole (positioning hole)
21 . . . terminal fitting
22 . . . terminal body portion
23 . . . fixing portion
24 . . . first flexible cable (flexible cable)
25 . . . first connecting end portion (welded section of flexible cable to terminal fittings)
25F . . . front end edge of first connecting end portion
25S . . . left and right side edges of first connecting end portion
26 . . . first through hole (positioning hole)
30 . . . second module
31 . . . second housing (housing)
32 . . . second terminal accommodating portion
33 . . . second terminal accommodation chamber (terminal accommodation chamber)
34 . . . second base plate portion
35 . . . second linking portion
36 . . . second opening (opening)
37 . . . second boss pin (boss pin)
38 . . . second fitting hole (positioning hole)
40 . . . second flexible cable (flexible cable)
41 . . . second connecting end portion (welded section of flexible cable to terminal fittings)
41F . . . front end edge of second connecting end portion
41S . . . left and right side edges of second connecting end portion
42 . . . second through hole (positioning hole)

1. A flexible cable connector, comprising:
a first housing formed with a plurality of first terminal accommodation chambers;
a second housing formed with a plurality of second terminal accommodation chambers;
a plurality of terminal fittings to be individually mounted into the plurality of first terminal accommodation chambers and the plurality of second terminal accommodation chambers;
a first flexible cable to be fixed to a plurality of the terminal fittings by welding,
a second flexible cable to be fixed to a plurality of the terminal fittings by welding,
the first housing being formed with a first opening for exposing a welded part of the plurality of terminal fittings and the first flexible cable,
the second housing being formed with a second opening for exposing a welded part of the plurality of terminal fittings and the second flexible cable,
the first housing and the first flexible cable being formed with positioning holes to be aligned with each other,
the second housing and the second flexible cable being formed with positioning holes to be aligned with each other,
a first module being configured by assembling the first housing, the plurality of terminal fittings and the first flexible cable,
a second module being configured by assembling the second housing, the plurality of terminal fittings and the second flexible cable,
a first boss pin formed on the first housing being fit into the positioning hole of the second housing and the positioning hole of the second flexible cable with the first and second modules stacked, and
a second boss pin formed on the second housing being fit into the positioning hole of the first housing and the positioning hole of the first flexible cable with the second and second modules stacked.

2. The flexible cable connector of claim 1, wherein:
the first opening is open to expose an outer peripheral edge of a welded section of the first flexible cable to the plurality of terminal fittings, and
the second opening is open to expose an outer peripheral edge of a welded section of the second flexible cable to the plurality of terminal fittings.

3-6. (canceled)
